(19) United States
(12) Patent Application Publication
(10) Pub. No.: US 2002/0120590 A1
(43) Pub. Date: Aug. 29, 2002

(54) Electronic taximeter

(75) Inventor: Claude Richard, Glencoe, IL (US)

Correspondence Address: BROWDY AND NEIMARK, P.L.L.C., 624 NINTH STREET, NW, SUITE 300, WASHINGTON, DC, 20001-5303, US

(73) Assignee: GLEIKE INC., Glencoe, IL (US)

(21) Appl. No.: 10/025,682

(22) Filed: Dec. 26, 2001

(30) Foreign Application Priority Data
Dec. 22, 2000 (FR) 00 16939

(51) Int. Cl. G06G 7/00; G06F 17/00; G07B 13/04

(52) U.S. Cl. 705/417; 705/400

(57) ABSTRACT

An electronic taximeter (1), which comprises:

detection means (7) able to detect a signal transmitted by a toll post (11), when the vehicle (5) equipped with the taximeter (1) passes in proximity to said post (11);

locating means (12) able to determine the location of the vehicle, said means being activated at least when the detection means (7) detect the proximity of a toll post;

determination means able to determine the identification of the toll post thus detected, as a function of the location of the vehicle;

means able to calculate the amount of the toll thus determined;

means (2) for displaying the amount thus calculated.

### TECHNICAL FIELD

The invention pertains to the field of taximeters. It is more particularly aimed at an improved taximeter which is designed to take account of the price of the tolls crossed by the taxi, with a view to incorporating this price into the amount for the trip paid by the customer.

### PRIOR ART

Given the developments in motorway networks, it is becoming ever more frequent for a taxi trip to follow pay-per-use sections, requiring the payment of a toll. These pay-per-use zones may either be a motorway stretch, or the span of a particular civil engineering structure, such as a tunnel or a bridge.

Payment of the amount of the toll may be made either on entry to the relevant stretch, or at the end thereof, when several exits may be used.

Payment of the amount of the toll may be made in various ways. Thus, vehicles may be requested to stop so as to pay the price corresponding to a post, via various types of means of payment, i.e. payment by cash, or via a particular payment facility such as a bank card or a subscription card.

Payment may also be effected without requiring the vehicle to stop at a toll post. In this case, the vehicle is equipped with a particular electronic circuit, generally referred to as a “transponder”. When the vehicle passes in proximity to the toll post, the transponder receives a particular signal in a specified frequency. In response, the transponder transmits a signal allowing the toll post to identify the approaching vehicle. With this identification, the toll operator can engage a payment procedure in accordance with the terms which he has defined with the user.

In document U.S. Pat. No. 5,864,831 there is described a sophisticated device making it possible to ensure toll payment whose price varies as a function of multiple parameters. Specifically, indeed over certain motorway sectors, or over certain civil engineering structures, the price of the toll may be dependent on the weight of the vehicle, on the level of pollution, or else on the maximum speed. The device described in this document makes it possible to calculate the amount corresponding to each specific case.

The determination of the toll to be taken into account is ensured by virtue of a system for locating the position of the vehicle, for example by a satellite-operated system, known by the name “GPS” standing for “Global Positioning System”.

The entire motorway network is recorded in this device. Depending on the specified location, and on the various other parameters, the device calculates the exact price of the toll. This device has a major drawback since it requires the recording of the entire motorway network and since it continuously compares the position of the vehicle with the mapped record of the network. These operations are relatively numerous, and demand very great accuracy as regards the locating means. Specifically, in the case where two roads are situated side by side, and when only one of them is a toll road, it is necessary for the accuracy of positioning to make it possible to distinguish whether the road traveled is or is not a toll road.

The problem which the invention sets out to solve is that of the incorporation of the amount of the toll into the total price for the taxi trip.

One of the objectives of the invention is to allow this incorporation while eliminating any risk of fraud, so as to ensure that the customer will actually be billed for the exact amount of the toll. Specifically, hitherto, the amounts of the toll are generally added to the amount for the trip, when the latter has finished. It is therefore the driver who fixes the amount of the toll which he should add to that for the trip, with the corresponding risk of fraud.

The invention therefore proposes a taximeter which makes it possible to fulfill these objectives in a simple and safe manner.

### DESCRIPTION OF THE INVENTION

The invention relates to an electronic taximeter which comprises:

detection means able to detect a signal transmitted by a toll post, when the vehicle equipped with the taximeter passes in proximity to said post;

locating means able to determine the location of the vehicle, said means being activated at least when the detection means detect the proximity of a toll post;

determination means able to determine the identification of the toll post thus detected, as a function of the location of the vehicle;

means able to calculate the amount of the toll thus determined;

means for displaying the amount thus calculated.

Stated otherwise, the taximeter reacts to the receiving of a signal transmitted by the toll post, signifying that the vehicle is just about to cross the toll barrier. When the taximeter receives this information, it triggers a process for determining the price of the toll. This determination involves the prior locating of the vehicle which may be done by extremely varied means. When the location of the vehicle has been determined, the taximeter deduces therefrom the toll post to which it is in proximity. The price of the toll is thus calculated, and it can thus be communicated to the taxi customer.

In a particular embodiment, the detection means may comprise:

a circuit tuned to a frequency corresponding to that of the signals transmitted by the toll posts;

a rectifier associated with said tuned circuit;

a level detector connected to said rectifier.

Thus, when the level detected is above a predetermined threshold, the process for determining the price of the toll is triggered by the taximeter.

In a particular embodiment, the detection means may consist of a part of the transponder used for the payment of the toll by the taxi driver.

Various types of means of locating vehicles may be used.

Thus, the locating means may be able to receive signals transmitted by the connection towers of a cellular telephony network. In this case, the locating means are able to determine the identification number of the connection tower closest to the vehicle or of a tower close to the vehicle. Thus, depending on the number of a close connection tower, the taximeter can determine the toll post to which the taxi is in proximity.

In practice, when location is effected by virtue of the connection towers of a cellular telephone network, the locating means may consist of a cellular telephone proper, suitably connected to the taximeter. It may also be a radio modem such as the digital modems operating according to the “GPDP” standard within GSM data technology used in Europe, or the “CDPD” standard used in the United States.

Location may also use a satellite-based positioning device, generally referred to as “GPS” standing for “Global Positioning System”.

It may also be some other type of locating system, operating for example by triangulation by means of radio waves. This principle of location may possibly be accessible on cellular telephones.

During the process for determining the price of the toll, the locating means may be activated according to various modes of operation.

Thus, the locating means may be activated solely at the moment of detecting the proximity of a toll post. Stated otherwise, it is when the detection circuit detects the proximity of the toll that the locating means are set into operation.

In a variant embodiment, the locating means are activated on the basis of detecting the proximity of a toll post, in such a way as to determine the alterations in the location, and in particular the direction of motion of the vehicle, subsequent to the detecting of the toll post. Therefore, the taximeter can determine the way in which the taxi travels after the toll post.

It is thus possible to determine the direction of travel of the taxi and hence to distinguish between two contiguous toll barriers which are however situated on different traffic lanes.

In another variant embodiment, the locating means are activated continuously, in such a way as to determine the alterations in the location and in particular the direction of motion of the vehicle, as soon as the proximity of the toll post is detected. This therefore makes it possible to trigger the process for calculating the price of the toll more quickly, since the direction of travel is determined very quickly. However, it may nevertheless prove to be necessary to continue the determination of the location of the vehicle so as to discriminate between changes of direction subsequent to the passing of the toll barrier.

Advantageously in practice, the means for determining and for identifying the toll post as a function of the location of the vehicle comprise a database. This database may either be programmed into the microprocessor including the taximeter, or else be downloadable into the latter. The programming may take place on an ad-hoc basis, by intervention of the manufacturer of the taximeter, or by the installer, or else an inspector or an authorized repairer.

In a particular form, the database can be downloaded on request by the driver, by connection with a remote computer site including for example a server connected to the Internet. The connection is then effected by virtue of the radio modem or the cellular telephone which is already used for the vehicle locating function. Downloading may also be automatic, in a periodic manner, so as to ensure regular updating of the database.

The downloading of the database may also be done in real time. In this case, the database is interrogated during detection of the proximity of a toll post. The latter variant has the advantage of allowing the updating of the price of the toll as soon as the modifications occur. This connection or this frequent downloading also makes it possible to adapt to alterations in the layout of the connection towers of cellular telephony networks, when the taximeter uses such locating means.

In practice, the displaying of the amount may be done either on the screen of the taximeter, or on the receipt printed at the end of the trip, or else according to both these formulae.

Advantageously in practice, the amount of the toll may be added to the amount for the trip as determined at the moment of detection, so that the price for the trip as displayed on the dial of the taximeter incorporates the amount of the toll. Advantageously, the addition of this toll may be signaled on the taximeter by an announcing message such as “Toll” in English-speaking countries. The displaying of the price of the toll may temporarily replace the price for the trip intermittently. It is also possible alternatively to display the price to be paid and the total “Extras”, including in particular the amount of the toll.

Advantageously the price of the toll may be transcribed into a chronological log of the tolls at the same time as the “For Hire” or “On Hire” state of the taxi and the driver's number and other information. This log allows the taxi vehicle hire company to ensure the management of the use of the remote-toll “transponders”. This makes it possible to combat the misuse by individuals of transponders perpetrated by certain drivers who hire out the taxi vehicle. This log may be recorded in the taximeter or in a remotely sited database.

The price of the toll is also advantageously added in two totalizers by the driver corresponding to the tolls traversed either in the “For Hire” position or in the “On Hire” position, this making it possible to discriminate between cases where the tolls have been paid within the framework of a trip or otherwise.

### BRIEF DESCRIPTION OF THE FIGURES

The manner in which the invention may be embodied, as well as the advantages stemming therefrom will emerge clearly from the description of the embodiment which follows, given by way of nonlimiting example, in support of the appended figures, in which:

FIG. 1 is a diagrammatic overall view of a toll barrier and of a vehicle equipped with a taximeter in accordance with the invention.

FIG. 2 is a diagram of a taximeter in accordance with the invention, equipped with the characteristic means.

### MANNER OF EMBODYING THE INVENTION

As already mentioned, the invention relates to an improved taximeter which makes it possible to incorporate the amounts of the tolls paid during the trip, in such a way as to display them for the customer, and/or to integrate them into his receipt serving as his bill.

In a general manner, such a taximeter (1) as illustrated in FIG. 2 comprises a conventional box, into which is built in a known manner a display dial (2) and a keypad (3) allowing the activation of various functions. Such a taximeter (1) comprises an electronic card which includes a microprocessor (4) able to manage the various processing functions in respect of the proper operation of the taximeter.

In accordance with the invention, the box of the taximeter (1) is connected to detection means (7), which are intended to allow the detection of the proximity of a toll post. Various detection means may be used, in correspondence with the transmitter systems of the toll posts. Thus, such detection means may consist of an electronic circuit mounted behind the windscreen of the vehicle. Such a circuit (7) may for example consist of a tuned circuit (8) associated with a rectifier (9) and with a level detector (10). In one variant, the tuned circuit may also be interfaced via an analog/digital converter installed directly on an electronic card of the taximeter.

Advantageously the detection means will consist of an antenna etched on a printed circuit board disposed in the taximeter or on the mount for securing the taximeter so as to be within the direct field of the transmitter of the toll post, through the windscreen.

The tuned circuit (8) is centered on the frequency of this transmitter generally in the UHF range, and for example in the vicinity of a GigaHertz.

Specifically, the posts used within the framework of the automatic payment of tolls transmit relatively powerful signals, in the UHF band.

Thus, the detection means (7) send the microprocessor (4) of the taximeter (1) the information according to which a signal of sufficient energy has been received originating from a toll post.

Of course, the invention is not limited to this form of detection circuit alone, but also covers all the variants which make it possible to detect the signals generally transmitted by the toll posts used for the purpose of automatic payment.

In accordance with the invention, the box (1) of the taximeter is also linked to locating means. In the nonlimiting example illustrated, these locating means may consist of a radio-modem (12). The expression radio-modem is intended to mean a device which can be interfaced with an electronic apparatus, and which is able to transmit and receive signals to and from a cellular telephone network. Such a radio-modem (12) may for example operate in certain frequency bands or channels allowing data transport, as opposed to the band intended for the transport of speech. Such a radio-modem may therefore operate according to the GPRS standard on a GSM type cellular telephony network, or else according to the CPDP standard on one of the diverse cellular telephony networks in force in the United States.

The radio-modem (12) is therefore equipped with an antenna (13) which may possibly be built in. This radio-modem (12) may be integrated into the taximeter, or else be sited remotely in a particular zone of the vehicle.

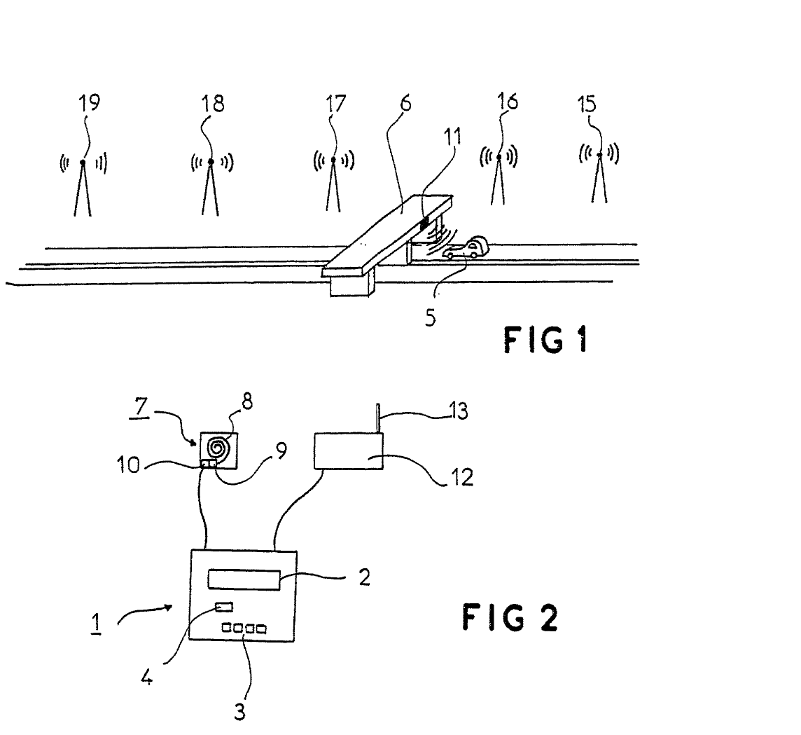

In the course of operation, the radio-modem (12) receives the signals transmitted by the various towers (15-19) within reception range of the path of the vehicle, as illustrated in FIG. 1.

Among the various towers (15-19) which transmit to the radio-modem (12), just one talks to the latter. This is the tower which serves as entry point to the cellular telephone network, and which is generally closest to the antenna (13) of the modem. Each tower (15-19) is identified by a different number. This number forms part of the data transmitted by the tower which are received by the radio-modem (12). In a known manner, the radio-modem selects the available tower (15-19) which corresponds to the most powerful signal received, generally corresponding to the shortest distance. Since the cellular telephony system is based on a multiplicity of short-range towers, this will in all cases be a tower close to the vehicle.

The transmitters which are disposed on the towers (15-19) transmit on various frequencies or “channels”. Each of these transmitters indicates the identification number of the tower on which it is installed. The radio modem (12) scans the various channels so as to find the transmitter which is best received, this generally being on the closest tower. The radio modem (12) then locks on to the corresponding channel so as to talk to this transmitter or more succinctly with the tower which it has chosen.

In the course of operation, the modem (12) can therefore identify the tower (15-19) to which it is connected, and inform the microprocessor (4) of the taximeter (1) of the identification number of this tower. It should be noted that from time to time, along a journey, the link is not ensured with any tower. This absence of tower is taken into account by the microprocessor.

According to a particular mode of operation of the taximeter (1) the microprocessor records the identification numbers of the various towers as and when they are detected by the modem (12).

Advantageously, the acquisition of the tower numbers is performed at regular intervals of distance traveled, for example every 50 meters. The corresponding identification numbers are stored for a duration corresponding to a predetermined distance traveled, for example corresponding to the last kilometer. The determination of the distance traveled is performed by the taximeter which is in essence equipped with appropriate means.

When the vehicle (5) such as illustrated in FIG. 1 arrives in proximity to a toll barrier (6), it enters the field of the transmitting post (11). The detection circuit (7) therefore detects the presence of the post (11) and informs the microprocessor (4) of this. At this moment, the microprocessor (4) investigates which is the identification number of the tower (16) to which the modem (12) is connected.

The microprocessor is programmed so as to have access to a database which matches up the identification number of the tower (16) and the amount of the toll to be paid when passing the toll barrier (6).

In certain particular cases, the simple information of locating the vehicle may not be sufficient to determine the amount of the toll. Such is the case when several traffic lanes give rise to different payments or else when the direction of crossing of the toll barrier (6) induces different payments.

In this case, the taximeter can compare the identification number of the tower (16) to which the modem (12) is connected at the level of the toll post, with the identification number of the tower (15) with which it was previously in connection. In this case, this comparison makes it possible to determine the direction of travel and hence the direction of crossing of the toll bar (6).

Another solution consists in determining the identification number of the tower to which the modem (12) will be connected after passing the toll barrier. For complex road network configurations, a combination of these two formulae will make it possible to resolve ambiguities in the case of multiple tolls. In this case, the list of identification numbers of the connection towers (15-19) to which the modem is connected during the journey is held in memory by the microprocessor.

Nevertheless, in the simplest configurations, the mere identification of the tower closest to the toll post (11) may suffice to determine the amount of the toll.

It should be noted that when the taxis cross certain zones such as certain tunnels or metal bridges, just one tower of the cellular telephony network is accessible. In this case, if the identification number of the tower remains constant, despite traveling a certain distance calculated by the microprocessor, the latter will automatically deduce that the taxi has entered a bridge or a tunnel, and will deduce therefrom the direction of crossing of the toll and hence its amount.

As already mentioned, the match-up between the location of the vehicle (5) and the amount of the toll to be paid is recorded in a database or match-up table. This match-up table can be programmed into a memory accessible by the microprocessor (4) of the taximeter. This programming may take place via authorized persons during the general programming of the taximeter, or else during inspection visits. This database can also be downloaded regularly and automatically, or else on request by the driver.

In this case, the alterations in the amounts of the tolls, as well as the list of identifications of the towers of the cellular telephony network are incorporated automatically by the taximeter.

In a particular form, the taximeter can interrogate a remote database. This database contains the match-up table of correspondences between the identification number of the tower of the cellular telephony network and the amount of the toll to be paid. This interrogation can be effected using the cellular telephony network to which the modem (12) is connected, by transmitting the requests via the latter.

In this case, the radio modem (12) serves both as locating means, and also intervenes in the means making it possible to calculate the amount of the toll.

In the case where it is necessary to discriminate between several toll lanes, or the direction of traffic flow, the interrogation of the database is performed by transmitting the set of identification numbers of the towers before the toll and possibly the set of identification numbers of the towers after the toll. In the second case this makes it possible also to determine the direction of crossing of the toll.

In an advantageous particular form, the characteristic database can be hosted on an Internet site, for example with an access-limiting authentication protocol.

When the microprocessor (4) determines the amount of the toll, by local or remote interrogation of the database, it brings about the display thereof on the dial (2) of the taximeter. This display may take place for a specified duration possibly with an audible or luminous mechanism for warning the customer. The latter may thus assimilate the amount of the toll which will be added to the total amount for the trip.

The taximeter can also increment the current amount for the trip by the amount of the toll thus calculated.

When the trip has finished, and when the driver requests the printing of the receipt, the latter shows the amount for the trip, the amount of the tolls, and the sum total.

Of course, the invention is not limited solely to the embodiment described in detail hereinabove, in particular as regards the means of location by interrogation of the neighboring cellular telephony network. Specifically, other types of locating means may be employed and in particular the systems operating by reception of signals emanating from satellites, and generally dubbed GPS standing for “Global Positioning System”.

In this case, the radio modem can be replaced by a GPS device, which sends the microprocessor (4) of the taximeter a certain number of items of information. This information may be a pair of longitude coordinates, possibly accompanied by an uncertainty value.

In this case, the microprocessor interrogates the database which instead of the cellular tower numbers contains the corresponding latitude and longitude values of the toll barriers.

Other locating means may be employed such as in particular those which use radio-wave-based triangulation systems.

It emerges from the foregoing that the taximeter in accordance with the present invention has multiple advantages and in particular:

the possibility of automatically integrating the amount of the tolls paid by the taxi into the total amount for the trip;

real-time updating of the amounts of the tolls and of their location;

reduction in the risks of fraud, since the amounts of the tolls are added to the amount for the trip by the microprocessor, without intervention by the driver;

elimination of the risk of erroneous billing when passing in the geographical vicinity of a toll, for example in the configuration of a bridge passing above a toll or of a free lane parallel to a toll lane.

The possibility of establishing a chronological log of the tolls, wherein are recorded for each toll crossing, the amounts, the state of the taxi, “For Hire” or “On Hire”, the date and the time, thereby making it possible to manage the use of the remote-toll “transponders”.

The distinguishing of the amounts of the tolls paid, by the driver depending on whether the taximeter is in the “For Hire” position or in the “On Hire” position.

1. An electronic taximeter (1), which comprises:
detection means (7) able to detect a signal transmitted by a toll post (11), when the vehicle (5) equipped with the taximeter (1) passes in proximity to said post (11);
locating means (12) able to determine the location of the vehicle, said means being activated at least when the detection means (7) detect the proximity of a toll post;
determination means able to determine the identification of the toll post thus detected, as a function of the location of the vehicle;
means able to calculate the amount of the toll thus determined;
means (2) for displaying the amount thus calculated.

2. The taximeter as claimed in claim 1, wherein the detection means (7) comprise:
a circuit (8) tuned to a frequency corresponding to that of the signals transmitted by the toll posts (11);
a rectifier (9) associated with said tuned circuit (8);
a level detector (10) connected to said rectifier (9).

3. The taximeter as claimed in claim 2, wherein the tuned circuit consists of an antenna etched on a printed circuit board disposed in the taximeter or on the mount for securing the Taximeter, itself intended to be installed on the rear of the windscreen of the vehicle, so as to be within the field of the transmitter of the toll post through the windscreen of the vehicle.

4. The taximeter as claimed in claim 1, wherein the locating means (12) are able to receive the signals transmitted by the connection towers (15-19) of a cellular telephony network.

5. The taximeter as claimed in claim 4, wherein the locating means are able to determine the identification number of a connection tower (16) close to the vehicle (5).

6. The taximeter as claimed in claim 4, wherein the locating means comprise a cellular telephone.

7. The taximeter as claimed in claim 4, wherein the locating means comprise a radio modem (12).

8. The taximeter as claimed in claim 1, wherein the locating means include a GPS positioning device.

9. The taximeter as claimed in claim 1, wherein the locating means are activated at the moment of detecting the proximity of a toll post.

10. The taximeter as claimed in claim 1, wherein the locating means are activated on the basis of detecting the proximity of a toll post (11), in such a way as to determine the alterations in the location, and in particular in the direction of motion of the vehicle (5), subsequent to the detecting of the toll post.

11. The taximeter as claimed in claim 1, wherein the locating means are activated continuously, in such a way as to determine the alterations in the location and in particular the direction of motion of the vehicle, as soon as the proximity of the toll post (11) is detected.

12. The taximeter as claimed in claim 5, wherein the acquisition of the tower identification numbers is performed at regular intervals of distance traveled.

13. The taximeter as claimed in claim 5, wherein the identification numbers of the towers are stored for a duration corresponding to a predetermined distance traveled.

14. The taximeter as claimed in claim 1, wherein the means for determining the identification of the toll post (11) as a function of the location of the vehicle comprise a database.

15. The taximeter as claimed in claim 14, wherein the database is programmed in the microprocessor (4) included in the taximeter (1).

16. The taximeter as claimed in claim 14, wherein the database can be downloaded into the taximeter.

17. The taximeter as claimed in claim 14, wherein the database is hosted within a remote computer site, and is interrogated during the detection of the proximity of a toll post (11).

18. The taximeter as claimed in claim 14, wherein the database includes the amount of the toll.

19. The taximeter as claimed in claim 1, wherein the displaying of the amount of the toll is done on the screen (2) of the taximeter.

20. The taximeter as claimed in claim 1, wherein the displaying of the amount of the toll is done by printing on the receipt printed at the end of the trip.

21. The taximeter as claimed in claim 1, wherein the amount of the toll is added to the amount for the trip, at the moment of detection.

22. The taximeter as claimed in claim 1, wherein the amounts of the toils are recorded in a chronological log.

23. The taximeter as claimed in claim 1, wherein the amounts of the tolls traversed in the for hire position are aggregated in a particular register.

24. The taximeter as claimed in claim 1, wherein the amounts of the tolls traversed in the “On Hire” position are aggregated in a particular register.
